(19) United States
(12) Patent Application Publication
(10) Pub. No.: US 2017/0221010 A1
(43) Pub. Date: Aug. 3, 2017

(54) SYSTEM AND METHOD FOR DATA MINING MESSAGING SYSTEMS TO DISCOVER REFERENCES TO COMPANIES WITH JOB OPPORTUNITIES MATCHING A CANDIDATE

(71) Applicants: Oliver Brdiczka, San Jose, CA (US); Sunil Kochikar Pai, Houston, TX (US); Sushant Tripathy, Fremont, CA (US); Amrit Saxena, Scottsdale, AZ (US); Richard Joffe, Palo Alto, CA (US); Adam D. Zoia, New York, NY (US)

(72) Inventors: Oliver Brdiczka, San Jose, CA (US); Sunil Kochikar Pai, Houston, TX (US); Sushant Tripathy, Fremont, CA (US); Amrit Saxena, Scottsdale, AZ (US); Richard Joffe, Palo Alto, CA (US); Adam D. Zoia, New York, NY (US)

(73) Assignee: Stella.Ai, Inc., New York, NY (US)

(21) Appl. No.: 15/488,835

(22) Filed: Apr. 17, 2017

Related U.S. Application Data
(60) Provisional application No. 62/376,364, filed on Aug. 17, 2016.

(51) Int. Cl. G06Q 10/10; G06F 17/30; G06Q 10/06; G06F 17/27

(52) U.S. Cl. CPC G06Q 10/1053; G06F 17/2705; G06F 17/30958; G06F 17/3053; G06F 17/30867; G06Q 10/063112

(57) ABSTRACT

An improved system and method for data mining messaging systems to discover references to companies with job opportunities matching a candidate is provided. The system and method disclosed may receive messages from messaging systems of a candidate and may construct a reference graph and a company graph that may provide a mapping to match a candidate with job opportunities identified from companies with a relationship to references. Job opportunities identified from the companies may be ranked by a match score weighted by a referral score. The system and method may thus rank job opportunities at those companies for a candidate where there is a relevant job for the candidate and the strongest references for the candidate. A list of job matches to the candidate that includes a list of references ordered by reference strength for each job match may be served for display to the candidate.

### FIELD OF THE INVENTION

The invention relates generally to computer systems, and more particularly to an improved system and method for data mining messaging systems of a candidate to discover references to companies with job opportunities matching the candidate.

### BACKGROUND OF THE INVENTION

Conventional recruiting processes are very labor intensive and expensive. Recruiters frequently identify, locate, and source candidates for a job through manual searches online and in social networks and find many candidates through referrals. Job candidates often send hundreds of applications to companies without getting any response to their application. Typically, a job applicant fares better in the application process with referrals from references known to a company where the applicant has applied for a job. It is important for job candidates to identify people and companies where the candidate has strong relationships that may help support moving their job application forward through the application process.

However, it is often difficult for job candidates to identify people and companies where the candidate has strong relationships. It is not unusual for some job candidates with extensive social networks to have thousands of contacts that may each have relationships with various companies. It can be difficult to ascertain which contacts are most beneficial to enlist for supporting job candidacy. Moreover, existing social networks fail to provide technological systems and processes that can identify people and companies where the candidate has strong relationships to support job candidacy. At best, some social networks may provide recruiting services for employers who use the service to match the employers' job profile to profiles of members of the social network to find members who meet or exceed the requirements of the employers' job. Such technological processes that fail to ascertain strong references from members' contacts that can support job candidacy may result in mismatches between candidates and jobs that lead to unexpected attrition rates and staffing costs.

What is needed are improved technological processes and a system that can identify people and companies where a job candidate has strong relationships. Such technological processes and system should identify references that can assist candidates in supporting their job application through the application process for jobs they want at companies where they want to work.

### SUMMARY OF THE INVENTION

Briefly, a system and method for data mining a candidate's messaging systems to discover references to companies with job opportunities matching the candidate is presented. In various embodiments, a user client may be operably connected to a messaging server and a job server. The user client may include a messaging application having functionality for sending messages to and receiving messages from other users, and the user client may include a personal recruiting application having functionality for communicating with an online application on the job server. The user client may communicate to a job server through a network and receive from the job server a short list of jobs matched for the user with associated references.

In various embodiments, the job server may support services for data mining messaging systems to discover job opportunities matching a candidate with associated references. In particular, the job server may include a message processor that may retrieve and process messages from a messaging system and a referral network generator that may receive parsed elements of messages from messaging systems and construct a reference graph and a company graph that may provide a mapping to match a candidate with job opportunities identified from companies with a relationship connection to references.

To do so, the referral network generator may include a reference graph constructor that may generate a representation of a reference graph having a node for the user representing the candidate and nodes for the other communicants of messages representing the references. The reference graph constructor may include a reference importance calculator that determines the importance of a node in the graph, a communications importance calculator that determines the importance of an edge in the graph representing the messages sent between two nodes in the graph, a message importance calculator that determines the importance of a message between two nodes in the graph, and a reference strength calculator that determines the relationship strength of each node by generating a reference strength score as a product of a value representing the importance of each node in the graph, a value representing the importance of each edge in the graph, and a value representing the average importance of each message between two nodes in the graph.

The referral network generator may also include a company graph constructor that may determine relationship connections to companies for each node of the referral graph and may generate a representation of a company graph of nodes representing the companies. The company graph constructor may include a company connector that determines the relationship connections for a node of the reference graph to a company and a company referral score generator that determines a referral score for each company with a relationship connection for a node in the reference graph.

A candidate may be matched with job opportunities identified from the companies with a relationship connection to the references. In an embodiment on a job server, a search may be made by a job search engine for open jobs in the companies and the retrieved open jobs may each be matched by a job match engine with a profile of the candidate to generate a match score weighted by the company referral score of the company that created the open job. A referral ranking engine may rank the open jobs by the match score for each open job. A list of references ordered by the reference strength score for each open job may also be generated. And, a short list of ranked job matches with references may be saved in server storage and served to a user client.

Conveniently, the system and method may automatically discover references for a candidate to a company for employment. Advantageously, the system and method for automatically identifying references to companies and job opportunities at those companies from extensive analysis of a candidate's messaging history may sift through thousands of communicants from a candidate's messaging history to discover the strongest references to a company that has a relevant job open for the candidate.

Other advantages will become apparent from the following detailed description when taken in conjunction with the drawings, in which:

### BRIEF DESCRIPTION OF THE DRAWINGS

FIG. 1 is a block diagram generally representing a computer system as an illustrative example in an embodiment;

FIG. 2 is a block diagram generally representing an architecture of system components for data mining messaging systems to discover job opportunities matching a candidate with associated references, as an illustrative example in an embodiment;

FIG. 3 is a flowchart generally representing the steps undertaken in an embodiment for data mining messaging systems to discover job opportunities matching a candidate with associated references;

FIG. 4 is a flowchart generally representing the steps undertaken in an embodiment for generating a reference strength score for nodes in the reference graph; and

FIG. 5 is a flowchart generally representing the steps undertaken in an embodiment for generating a company referral score for nodes in the company graph.

### DETAILED DESCRIPTION

### Exemplary Operating Environment

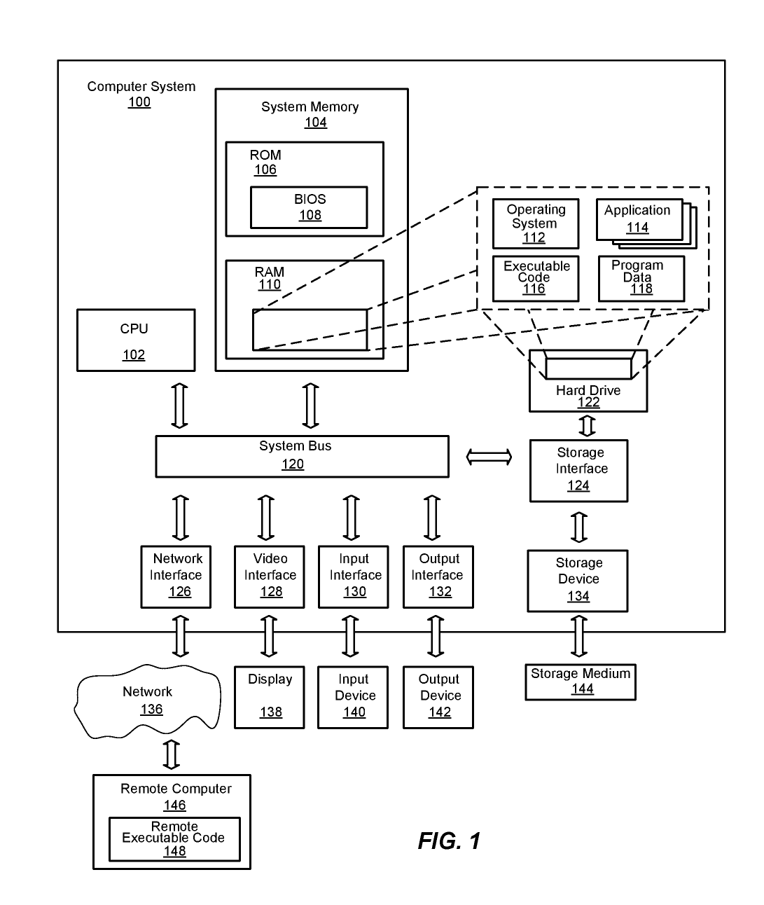

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be a solid-state drive that reads from or writes to non-removable, nonvolatile solid-state storage. Alternatively, storage device 134 may be a solid-state drive, an optical disk drive or a magnetic disk drive that reads from or writes to a removable, a nonvolatile storage medium 144 such as solid-state storage, an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

Those skilled in the art will appreciate that the computer system 100 may also be implemented within a system-on-a-chip architecture including memory, external interfaces and an operating system.

Data Mining Messaging Systems to Discover References to Companies with Job Opportunities Matching a Candidate

A system and method is disclosed in various embodiments that are generally directed to data mining messaging systems to discover references to companies with job opportunities matching a candidate. More particularly, the system and method disclosed may receive messages from a candidate's messaging systems and may construct a reference graph and a company graph that may provide a mapping to match a candidate with job opportunities identified from companies with a relationship connection to references. As used herein, a messaging system means a computer system that provides a communication history of messages or recorded voice between users of the system and may include such systems as email, instant messaging, text messaging, voice mail, and so forth. A relationship connection as used herein means a former or present relationship as a business contact, previous employee, current employee, business vendor, business affiliate, or other business relationship. As will be seen, the system and method may automatically discover references for a candidate to a company for employment. Furthermore, the system and method may sift through thousands of communicants from a candidate's messaging history and automatically identify references to companies from extensive analysis of a candidate's messaging history and further identify job opportunities at those companies and the strongest references to each company where there is a relevant job for the candidate. As will be understood, the various block diagrams, flow charts and scenarios described herein are only examples, and there are many other scenarios to which the system and method disclosed will apply.

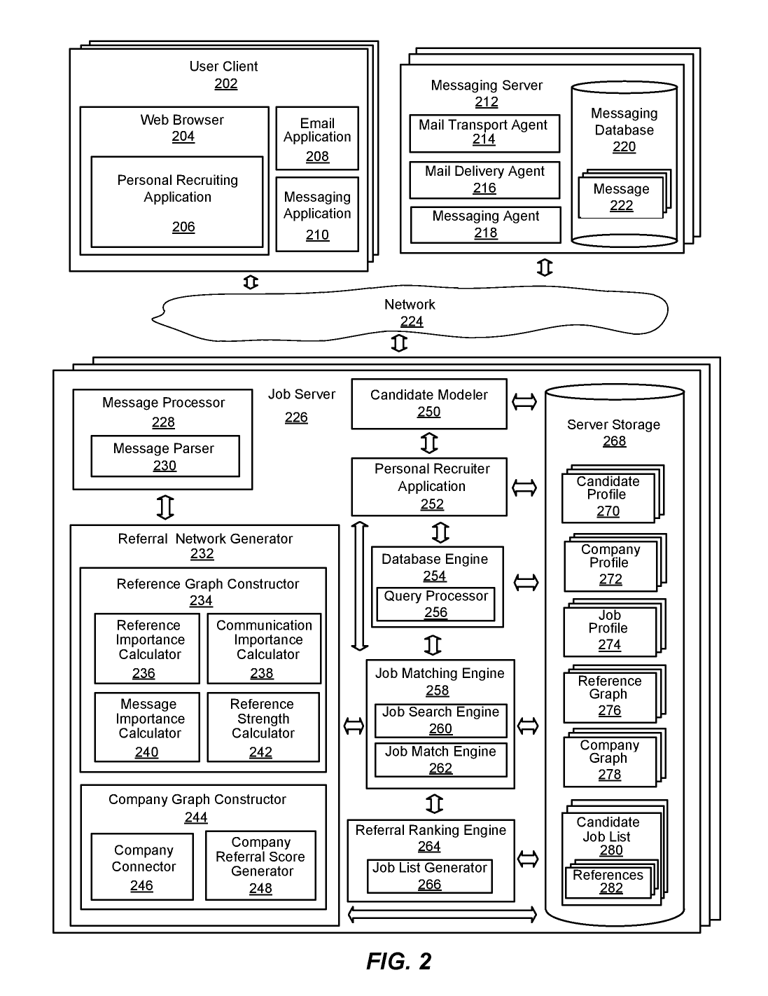

Turning to FIG. 2 of the drawings, there is shown a block diagram generally representing an architecture of system components in an embodiment for data mining messaging systems to discover job opportunities matching a candidate with associated references as an illustrative example. Those skilled in the art will appreciate that the functionality implemented within the blocks illustrated in the diagram may be implemented as separate components or the functionality of several or all of the blocks may be implemented within a single component. For example, the functionality for the personal recruiting application 206 on the user client 202 may be implemented as a separate component from the web browser 204, which may be the case for a mobile device such as a smartphone. Note that in an embodiment on a mobile device, the functionality of the personal recruiting application 206 may be implemented both within the web browser 204 as shown and as a separate component so that a mobile device user may use either the web browser 204 with the functionality of the personal recruiting application 206 included or the personal recruiting application 206 as a separate application component. As another example, the functionality of the reference graph constructor 234 and the company jobs graph constructor 244 may be implemented in an alternate embodiment within a single component. Moreover, those skilled in the art will appreciate that the functionality implemented within the blocks illustrated in the diagram may be executed on a single computer or distributed across a plurality of computers for execution. Furthermore, those skilled in the art may also appreciate that the functionality implemented within the blocks illustrated in the user client 202 may also be implemented using a thin client whereby the functionality of the web browser 204 and the personal recruiting application 206 may be implemented on the job server 226, and the functionality of the email application 208 and the messaging application 210 may be implemented on the messaging server 212. In such an embodiment, the user client 202 merely acts as an interface for a user to interact with the job server 226 and the messaging server 212.

In various embodiments, a user client 202 may communicate with one or more messaging servers 212 and with one or more job servers 226 through a network 224. The user client 202 may be a computer such as computer system 100 of FIG. 1 or another computing device including a mobile device such as a mobile phone. The network 224 may be any type of network such as the Internet, a cellular network, a local area network (LAN), a wide area network (WAN), or other type of network. A web browser 204 may execute on the user client 202 and may include functionality for receiving a request to perform an operation which may be input by a user and functionality for sending the request to a server to perform the operation. The web browser 204 may be operably coupled to a personal recruiting application 206 having functionality for receiving requests to perform an operation for the personal recruiting application 206 and functionality for sending the requests to the job server 226 to perform the requested operation for the personal recruiting application 206.

Other applications may also execute on the user client 202 in various embodiments. For example, in embodiments where the user client 202 may be a computing device such as a mobile phone, a personal recruiting application 206 may execute on the mobile phone as a separate component from a web browser 204. The personal recruiting application 206 in this embodiment may have functionality for receiving requests to perform an operation for the personal recruiting application 206 and functionality for sending the requests to the job server 226 to perform the requested operation for the personal recruiting application 206.

Moreover, an email application 208 may execute on the user client 202 that may receive emails from other users to the user in various embodiments. Other messaging applications like messaging application 210 may also execute on the user client 202 that likewise serve to receive messages from other users to the user in an embodiment. Such messaging applications may be any type of messaging application including an instant messaging application, a text messaging application such as Simple Message Service (SMS), a chat messaging application, and so forth.

In general, the web browser 204, the personal recruiting application 206, the email application 208, and the messaging application 210 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The messaging server 212 may communicate with one or more user clients 202 through network 224 and may also communicate with one or more job servers 226 through network 224 in various embodiments. The messaging server 212 may be a computer such as computer system 100 of FIG. 1 or another computing device including a mobile device. The messaging server 212 may support email services for receiving incoming email messages for an email account assigned to the messaging server 212 and storing the email messages for email accounts in a messaging database. In particular, the messaging server 212 may include a mail transport agent 214 which includes functionality to receive email messages for email accounts assigned to the messaging server 212, a mail delivery agent 216 which includes functionality to store the email messages for email accounts assigned to the messaging server 212 in a messaging database, and a messaging agent 218 which includes functionality to receive requests from an email client to retrieve email messages stored in the messaging database for email accounts assigned to the messaging server 212. The messaging server 212 may also be operably coupled to a messaging database 220 that stores email messages 222 for email accounts.

The mail transport agent 214, the mail delivery agent 216, and the messaging agent 218 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The job server 226 may be any type of computer system or computing device such as computer system 100 of FIG. 1. In general, the job server 226 may support services for modeling candidates, companies and jobs, and may support services for data mining messaging systems to discover job opportunities matching a candidate with associated references. In particular, the job server 226 may include a message processor 228 that may be operably coupled to a referral network generator 232. The message processor 228 may include functionality to retrieve and process messages from a messaging system and may include a message parser 230 having functionality to parse elements of the message such as the sender, receiver, date, message content, and so forth. The message processor 228 may for example retrieve messages from messaging server 212, process the messages and send the elements of the messages to the referral network generator 232.

The referral network generator 232 may be operably coupled to the message processor 228, the job matching engine 258, and server storage 268. The referral network generator 232 may include functionality for receiving elements of messages from messaging systems and functionality for constructing references graphs and company graphs that may be used to provide a mapping of job opportunities matching a candidate with associated references. Accordingly, the referral network generator 232 may include a reference graph constructor 234 having functionality for building a reference graph of uniquely identifiable nodes representing each sender and receiver of a message for the messages from one or more messaging systems. In an embodiment, the reference graph constructor 234 may include a reference importance calculator 236 having functionality for determining the relative importance of each node in the graph as compared to other nodes in the graph, a communications importance calculator 238 having functionality for determining the importance of each edge in the graph, a message importance calculator 240 having functionality for determining the importance of each message between two nodes in the graph and the average message importance between two nodes of the graph, and a reference strength calculator 242 for determining the relationship strength of each node.

The referral network generator 232 may also include a company graph constructor 244 having functionality for determining company connections for each node of the referral graph and having functionality for building a company graph with each node representing an individual company from the companies determined for each node of the referral graph. The company graph constructor 244 may include a company connector 246 having functionality for determining the company connections for each node of the referral graph and a company referral score generator 248 having functionality for generating a referral score for each company of the companies determined for each node of the referral graph.

The job server 226 may also include a personal recruiter application 252 that may be operably coupled to a candidate modeler 250, database engine 254, a job matching engine 258, and server storage 268. The personal recruiter application 252 may be implemented as an online application that includes functionality for interacting with the personal recruiting application 206 executing on a computing device, functionality for receiving candidate information from the personal recruiting application 206 and functionality for sending the candidate information to the candidate modeler 250 to generate or update a candidate profile 270. The personal recruiter application 252 may also include functionality for receiving a candidate job list 280 from the job matching engine 258 and functionality to retrieve a candidate job list 280 from server storage 268, functionality to send a candidate job list 280 to the personal recruiting application 206 for display on a computing device such as user client 202.

The job server 226 may also include a job matching engine 258 that may be operably coupled to the referral network generator 232, the personal recruiter application 252, a referral ranking engine 264, the database engine 254 and server storage 268. The job matching engine 258 may include functionality in an embodiment for receiving a request to search for job profiles of one or more companies, functionality for receiving a request to match a candidate profile to one or more job profiles, and functionality for sending a list of one of more job profiles to a referral ranking engine 264 to rank the job profiles. In an embodiment, the job matching engine 258 may include a job search engine 260 having functionality for searching for and retrieving job profiles of one or more companies, a job match engine 262 having functionality for matching a candidate profile to one or more job profiles and generating a match score weighted by the company referral score of the company that created the job. The job server 232 may also include a referral ranking engine 264 that may be operably coupled to the job matching engine 258, the database engine 254 and server storage 268. The referral ranking engine 264 may include functionality in an embodiment for receiving a request to rank a list of job matches scored by the job match engine 262 with a match score weighted by the company referral score, and functionality to generate a short list of ranked jobs for the candidate. In an embodiment, the referral ranking engine 264 may include a job list generator 266 having functionality to generate the short list of matching jobs.

The message processor 228 and each of its components, the referral network generator 232 and each of its components, the personal recruiter application 252, the candidate modeler 250, the job matching engine 258 and each of its components, the referral ranking engine 264 and each of its components, the database engine 254 and each of its components may each be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The job server 226 may additionally include a database engine 254 and server storage 268. The database engine 254 may provide database services and may include a query processor 256 having functionality to process received queries by retrieving the data from the server storage 268 and processing the retrieved data. The database engine 254, the job matching engine 258, the referral ranking engine 264, the personal recruiter application 252, and the candidate modeler 250 may be operably coupled to server storage 268 that stores information for candidate profiles 270, information for company profiles 272, information for job profiles 274, information for reference graphs 276, information for company graphs 278, and information for candidate job lists 280 including references 282.

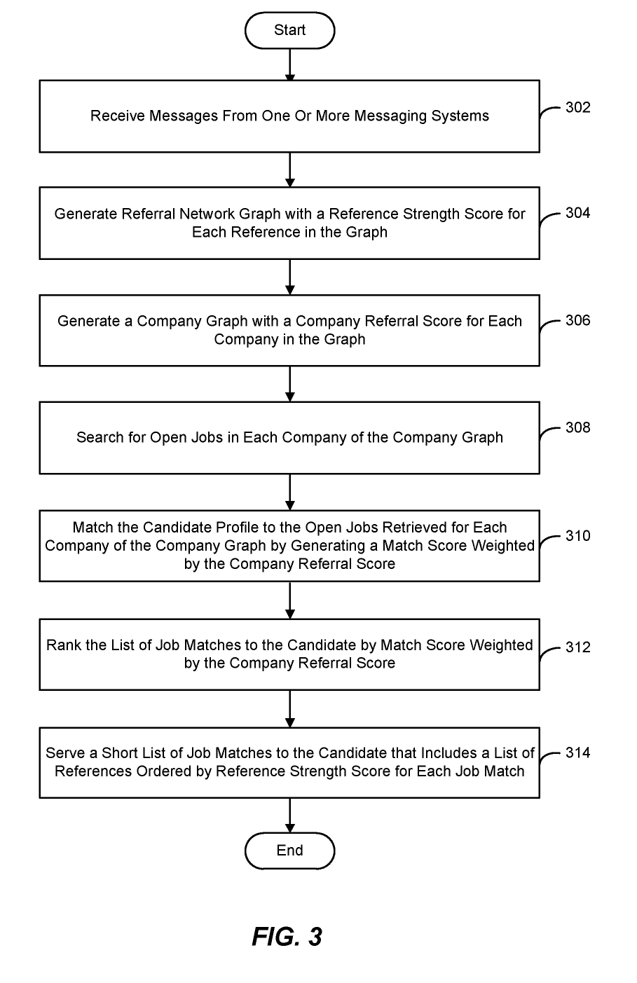

FIG. 3 presents a flowchart generally representing the steps undertaken in one embodiment for data mining messaging systems to discover job opportunities matching a candidate with associated references. At step 302, messages between a candidate and potential references from one or more messaging systems may be received. In an embodiment, an application on the client may interact with candidate to request and receive access to retrieve the candidate's communication history from one or more messaging servers. For instance, the personal recruiter application 206 executing on the client may interact with the candidate to receive access to retrieve the candidates email messages stored in a messaging database 220 on a messaging server 212. The message information including the sender, the receiver and the content of each message may be stored on a server such as job server 226 for further processing. In various embodiments, the communication history of other messaging systems used by the candidate may similarly be accessed, retrieved and stored for further processing. Such messaging systems may include SMS, instant messaging systems, social networking messaging systems, phone call logs including VOIP, and so forth.

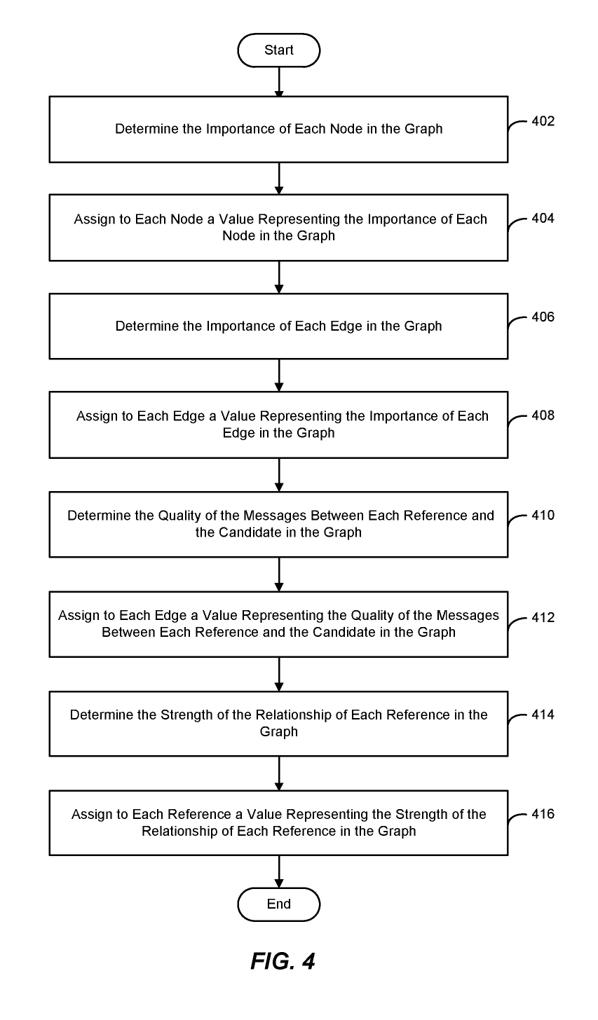

At step 304, a reference graph may be generated with a reference strength score for each reference in the graph. In an embodiment, each sender and receiver of each processed message from one or more messaging systems may be represented as a uniquely identifiable node in the reference graph. In various embodiments, a node of the reference graph and each of their attributes may be implemented as a record of a database table, and the attributes of the edges of the reference graph may be stored as a matrix value indexed by the row and column identifiers associated with the two nodes connected by the respective edge. Those skilled in the art will appreciate that other data structures may be used to represent the reference graph in an embodiment including a linked list, a tree, and so forth. The reference graph may be generated for instance by the reference graph constructor 234. A reference strength score may be generated for each node in the reference graph by the reference strength calculator 242 as described below in further detail in conjunction with FIG. 4 as a product of a value representing the importance of each node in the graph, a value representing the importance of each edge in the graph, and a value representing the average importance of each message between two nodes in the graph.

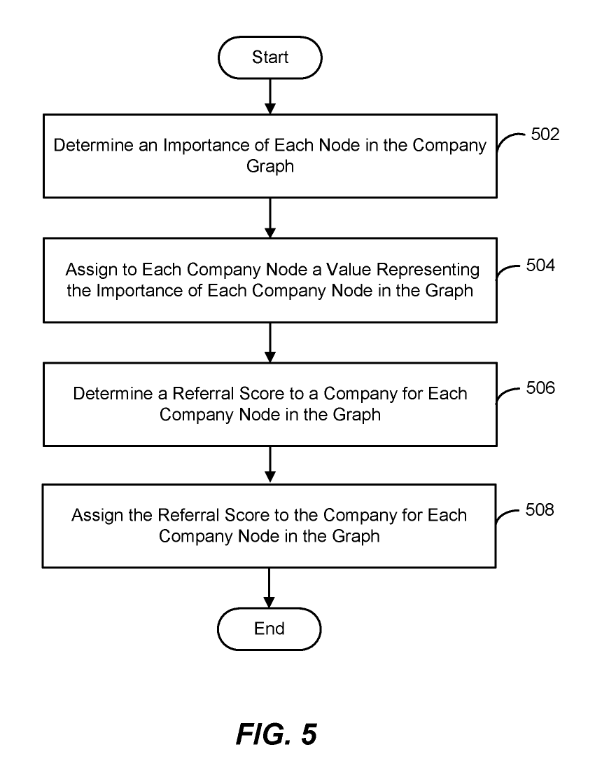

At step 306, a company graph may be generated with a company referral score for each company in the graph. A company referral score as used herein means a value representing the strength of a referral to a company. To identify companies connected to references, the company connector 246 may determine in an embodiment the company connections for each node of the referral graph. For instance, company affiliations for the recipients and senders of messages may be identified, and an edge weight representing the message importance of messages between them may be calculated. In an embodiment, the domain name may be parsed in the message address of a sender or receiver of each processed message from one or more messaging systems, and the domain name may be used to look up the company name and homepage in company profiles stored in server storage. In another embodiment, where there may be a signature to the message, the message may be parsed to extract the signature text of the message and the company within the signature text. In various embodiments, the name of the message box may be parsed in the message address of a sender or receiver of each processed message from one or more messaging systems, and available contact management software APIs, such as FullContact, may be invoked using the name of the message box of a sender or receiver to retrieve a resume that may be parsed to identify additional company connections including prior employment. The companies identified to each reference may be represented as a uniquely identifiable node in the company graph, and a weight representing the message importance of messages between the nodes may be calculated for each edge between the nodes. In various embodiments, a node of the company graph and each of their attributes may be implemented as a record of a database table, and the attributes of the edges of the company graph may be stored as a matrix value indexed by the row and column identifiers associated with the two nodes connected by the respective edge. Those skilled in the art will appreciate that other data structures may be used to represent the company graph in an embodiment including a linked list, a tree, and so forth. The company graph may be generated for instance by the company graph constructor 244. A company referral score may be generated for each node in the company graph by the company referral score generator 248 as described below in further detail in conjunction with FIG. 5 as a value representing the importance of each node in the company graph.

At step 308, open jobs in each company of the company graph may be searched and retrieved. In an embodiment, the job search engine 260 may search for and retrieve the job profiles for the companies with a referral score that exceeds the threshold from server storage 268. In various embodiments, additional jobs for the companies may be automatically searched and retrieved from the companies websites identified in the company profiles stored in the server storage. In yet other embodiments, open jobs for the companies may be automatically searched and retrieved from addresses of well-known job boards.

At step 310, the candidate profile may be matched to the open jobs retrieved for each company in the company graph by generating a match score weighted by the company referral score. The job match engine 262 may match a candidate profile to one or more job profiles in an embodiment and generate a match score weighted by the company referral score of the company that created the job. In various embodiments, the matching for job matches to the candidate profile may be based for example on text analysis that may measure the Levenshtein distance between the texts of the job descriptions of the candidate profile and the job profile, semantic analysis that may calculate the Jaccard similarity between the set of semantic entities extracted from the job descriptions of the candidate profile and the job profile, skill set analysis that may calculate the Jaccard similarity between the skills set extracted from the job descriptions of the candidate profile and the job profile in an embodiment, title analysis that may measure the Levenshtein distance between the texts of the job titles of the candidate profile and the job profile, experience analysis that may calculate the Jaccard similarity between the experience tags or words extracted from the job descriptions of the candidate profile and the job profile in an embodiment, and educational level analysis that may compare educational levels extracted from the job descriptions of the candidate profile and the job profile. Each of these analyses may yield a score in an embodiment that may be normalized, weighted and summed to generate a match score weighted by the company referral score as follows:

score=(μ1*score text+μ2*score semantic+μ3*score skills+μ4*score title+μ5*score experience+μ6*score education)*score company referral=1, assuming μ1+μ2+μ3+μ4+μ5+μ6=1, and each score is a value between 0 and 1. In various embodiments, alternate match scores may be generated by multiplying the company referral score by the sum of one or more of the normalized and weighted content score, such as the score text, score semantic, score skills, score title, the score experience, or the score education.

At step 312, the list of job matches to the candidate may be ranked by their respective match scores weighted by the company referral score. The referral ranking engine 264 may rank a list of job matches scored by the job match engine 262 with a match score weighted by the company referral score in an embodiment. And, at step 314, a short list of job matches to the candidate that include a list of references ordered by reference strength score for each job match may be served to the candidate. In an embodiment the short list may be sent to the user client 202, and the candidate may choose for which jobs to apply. Those skilled in the art will appreciate that in various embodiments a reference graph may not be generated with a reference strength score for each reference in the graph as described at step 304 and accordingly a short list of job matches may be served to a candidate at step 314 without including a list of references ordered by reference strength.

FIG. 4 presents a flowchart generally representing the steps undertaken in one embodiment for generating a reference strength score for nodes in the reference graph. In an embodiment, the reference strength score for a node in the graph may be a product of a value representing the importance of each node in the graph, a value representing the importance of each edge in the graph, and a value representing the average importance of each message between two nodes in the graph.

At step 402, the importance of each node in the graph may be determined. In an embodiment, the importance of a node in the graph may be generated by determining degree balance, degree centrality, and eigenvector centrality by the reference importance calculator 236. In various embodiments, a PageRank algorithm may be used to generate a variant of the eigenvector centrality. The degree balance of a node may be determined in an embodiment as follows:

$$DB ( N ) = \frac{ID ( N ) - OD ( N )}{ID ( N ) + OD ( N )} .$$

The degree centrality of a node may be determined in an embodiment as the node's in-degrees, out-degrees and total degrees. The eigenvector centrality of a node may be determined by finding the maximum eigenvalue λ of the adjacency matrix A for the equation Ax=λx, where the adjacency matrix A is weighted by message importance. In an embodiment, the message importance may be calculated as the sum of the messages between i and j, and the adjacency matric A may be accordingly weighted by message importance as follows: A(i,j)=Σᵢ₌₁^{N}I(Mₖ^{ij}). In another embodiment, the message importance may be calculated as the

$$AEI ( i , j ) = \frac{1}{\sqrt{N}} {\sum }_{i = 1}^{N} I ( {E}_{k}^{ij} ) ,$$

average importance of messages between the nodes, as described below in further detail in conjunction with step 410 of FIG. 4. At step 404, each node may be assigned a value representing the importance of the node in the graph. In an embodiment, the maximum eigenvalue λ for each node may be assigned to that respective node and represents the relative importance of that node to other nodes in the graph. In other embodiments, the PageRank algorithm may be used to generate a variant of the eigenvector centrality, and the eigenvalues generated by the PageRank algorithm may be assigned to each node in the graph. In yet another embodiment, an algorithm to compute the Katz centrality for the nodes of the graph may be used to generate a variant of eigenvector centrality, and the Katz scores representing the variants of eigenvalues of the Katz centrality may be assigned to each node in the graph.

At step 406, the importance of each edge in the graph may be determined. In an embodiment, the importance of an edge in the graph may be generated by determining communication balance, communication importance, and message importance. The communication balance between the nodes of an edge may be determined in an embodiment as follows:

$$CB ( i , j ) = \frac{A ( i , j ) - A ( j , i )}{A ( j , i ) + A ( i , j )} ,$$

where A(i,j) is an adjacency matrix indicating the number of messages sent from node i to node j. In an embodiment, the communication balance, CB(i,j), may be weighted by the average message importance sent from node i to node j, as described below in further detail in conjunction with step 410. The communication importance between the nodes of an edge may be determined in an embodiment by the communication importance calculator 238 using the value of the communication balance as follows:

$$CI ( i , j ) = \frac{CB ( i , j ) + 1}{2} .$$

The value of the communication importance, CI(i,j), may range between 0.5 and 1. In an embodiment, a filter condition may be employed to set the value of the communication importance to 0.5 if the number of messages between the nodes of an edge is low. For example, considering α to be the number of messages between the nodes of an edge, the communication importance, CI(i,j), may be set to the value of 0.5 for a filter condition where D(N)<α for α in the range [2,5] in an embodiment. At step 408, each edge may be assigned a value, such as the communication importance, CI(i,j), representing the importance of the edge in the graph.

At step 410, the quality of the messages sent between each reference and a candidate may be determined. In an embodiment, the message importance calculator 240 may determine the average message importance between the nodes of an edge and a value for the importance of a message may be based upon various attributes of the message. For instance, one attribute considered may be that a sender or receiver of a message is directly addressed, such as by first name. Another attribute considered may be that the message includes an attachment. Yet another attribute considered may be that the message includes a scheduling request, such as for a meeting or appointment. Those skilled in the art will appreciate that various other attributes may be considered in determining the importance of a message between the nodes of an edge. The message importance between the nodes of an edge may be determined in an embodiment by including these three attributes into one score as follows:

$$I ( {E}_{k}^{ij} ) = max ( \frac{1 [ direct address ] + 1 [ attachment ] + [ scheduling ]}{3} , 0.25 ) ,$$

where Eₖ^{ij} is the kth message sent from node i to node j. The average message importance scaled by the number of messages between the nodes of an edge may be determined in an embodiment as follows:

$$AEI ( i , j ) = \frac{1}{\sqrt{N}} {\sum }_{i = 1}^{N} I ( {E}_{k}^{ij} ) .$$

At step 412, a value, such as average message importance, AEI(i,j), representing the quality of the messages between each reference and the candidate in the graph may be assigned to each edge.

At step 414, the strength of the relationship of each reference in the graph may be determined. In an embodiment, a reference strength score may represent the strength of the relationship of each reference in the graph and may be generated by the reference strength calculator 242 as a product of a value representing the importance of each node in the graph, a value representing the importance of each edge in the graph, and a value representing the average importance of each message between two nodes in the graph as follows: R(i,j)=σ(CI(i,j)·AEI(i,j)·P(j)), where P(j) is a value representing the prominence of a reference from relatively unknown to successful in a range of [0.5,1] respectively. And, at step 416, a value, such as R(i,j), representing the strength of the relationship of each reference in the graph, may be assigned to each reference. In other embodiments, the strength of the relationship in the graph may be determined with respect to the candidate, represented as the central inbox node, o, by transforming R(i,j) to compute R(o,j) as follows: R(o,j)=σ(CI(o,j)·AEI(o,j)·P(i). The value, R(o,i), representing the strength of the relationship of each reference in the graph, may be assigned to each reference.

FIG. 5 presents a flowchart generally representing the steps undertaken in an embodiment for generating a company referral score for nodes in the company graph. In an embodiment, the company referral score for a node in the company graph may be a value representing the importance of each node in the company graph. As described above in further detail in conjunction with step 306 of FIG. 3, the companies identified to each reference may be represented as a uniquely identifiable node in the company graph, and a weight representing the message importance of messages between the nodes may be calculated for each edge between the nodes. At step 502, an importance of each node in the company graph may be determined. In an embodiment, the importance of a node in the company graph may be generated by the company referral generator 248 by determining the eigenvector centrality. The eigenvector centrality of a node may be determined by finding the maximum eigenvalue λ of the adjacency matrix A for the equation Ax=λx, where the adjacency matrix A is weighted by message importance. In an embodiment, the message importance may be calculated as the sum of the emails between i and j, and the adjacency matric A may be accordingly weighted by message importance as follows: A(i,j)=Σᵢ₌₁^{N}I(Mₖ^{ij}). In another embodiment, the message importance may be calculated as the average importance of messages between the nodes,

$$AEI ( i , j ) = \frac{1}{\sqrt{N}} {\sum }_{i = 1}^{N} I ( {E}_{k}^{ij} ) ,$$

as described above in further detail in conjunction with step 410 of FIG. 4. In various embodiments, a PageRank algorithm may be used to generate a variant of the eigenvector centrality. For instance, the PageRank algorithm may be used to generate the eigenvalues of CP(Cᵢ^{o}) that may represent the average company importance of a node in the company graph, where Cᵢ^{o} represents the list of companies for node i from the perspective of the central node representing the candidate, o, in the reference graph.

At step 504, a value representing the importance of each node in the company graph may be assigned to each node in the company graph. In an embodiment, the maximum eigenvalue λ for each node may be assigned to that respective node and represents the relative importance of that node to other nodes in the graph. In other embodiments, the PageRank algorithm may be used to generate a variant of the eigenvector centrality, and the eigenvalues of CP(Cᵢ^{o}) generated by the PageRank algorithm may be assigned to the respective nodes in the graph.

At step 506, a referral score to each company may be determined for each node in the company graph. In an embodiment, the company referral generator 248 may generate a referral score to each company as a value of the importance of the node in the company graph generated at step 504 above as follows: CP(Cᵢ^{o}). In another embodiment, the referral score to each company may be assigned the value as follows:

aCP_{cεCompanies}=FUN_{cεCompanyList(i)}R(o,i), where the reference strength values, R(o,i), of each non-central node, i, in the referral graph with respect to the central node o, the candidate, that have a company in their company list are combined using a function FUN(max, sum, average).

At step 508, a referral score to each company may be assigned to each node in the company graph. In an embodiment, the referral score generated by the computation of CP(Cᵢ^{o}) may be assigned to each respective node in the company graph. In another embodiment, the referral score generated by the computation of aCP_{cεCompanies}=FUN_{cεCompanyList(i)}R(o,i) may be assigned to each respective node in the company graph.

Thus, the company referral score may represent the strength of the relationship between the candidate and the company. Job opportunities at companies may be accordingly ranked by a match score weighted by the company referral score and, consequently, the company referral score may boost job matches in the ranking with the strongest references to each company where there is a relevant job for the candidate.

As can be seen from the foregoing detailed description, a system and method is disclosed in various embodiments that are generally directed to data mining messaging systems to discover references to companies with job opportunities matching a candidate. More particularly, the system and method disclosed may search for open jobs in each company where a relationship with a reference is discovered, and the candidate profile may be matched to the open jobs retrieved for each company by generating a match score weighted by the company referral score. Importantly, the system and method may identify and rank job opportunities at those companies for a candidate where there is a relevant job for the candidate and the strongest references for the candidate. As a result, the system and method provide significant advantages and benefits needed in contemporary computing and in online recruiting applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for discovering a referral for a candidate for employment, comprising:
a processor;
a message processor operably coupled to the processor that retrieves and parses into a plurality of message elements a plurality of messages between the candidate and a plurality of communicants from at least one messaging system used by the candidate;
a referral network generator operably coupled to the message processor that receives the plurality of message elements of the plurality of messages between the candidate and a plurality of communicants and constructs a reference graph with a reference strength score for each of the plurality of communicants indicating the strength of the relationship with the candidate;
a reference graph constructor operably coupled to the referral network generator that builds the reference graph of a plurality of uniquely identifiable nodes representing the candidate and the plurality of communicants from the plurality of message elements of the plurality of messages between the candidate and a plurality of communicants;
a reference strength calculator operably coupled to reference graph constructor that determines the reference strength score for each of the plurality of nodes representing the plurality of communicants that indicates the strength of the relationship with the candidate; and
a server storage operably coupled to the referral network generator that stores the reference graph with a reference strength score for each of the plurality of nodes representing the plurality of communicants that indicates the strength of the relationship with the candidate.

2. The system of claim 1 further comprising a reference importance calculator operably coupled to the reference graph constructor that calculates the relative importance of each of the plurality of nodes representing the plurality of communicants.

3. The system of claim 1 further comprising a communications importance calculator operably coupled to the reference graph constructor that calculates the importance of each of the plurality of edges representing the plurality of messages between the candidate and the plurality of communicants.

4. The system of claim 1 further comprising a message importance calculator operably coupled to the reference graph constructor that calculates the importance of each of the plurality of messages between the candidate and the plurality of communicants.

5. A computer system for discovering a referral to a company for a candidate for employment, comprising:
a processor;
a message processor operably coupled to the processor that retrieves and parses into a plurality of message elements a plurality of messages between the candidate and a plurality of communicants from at least one messaging system used by the candidate;
a referral network generator operably coupled to the message processor that receives the plurality of message elements of the plurality of messages between the candidate and the plurality of communicants;
a company graph constructor operably coupled to the referral network generator that constructs a company graph of a plurality of nodes representing a plurality of companies with which at least one of the plurality of nodes representing the plurality of the communicants has a relationship connection;
a company referral score generator operably coupled to the company graph constructor that generates a company referral score for each of the plurality of nodes representing the plurality of companies, the company referral score indicating a strength of a relationship between the candidate and one of the plurality of companies with which the one of the plurality of the communicants has a relationship connection; and
a server storage operably coupled to the referral network generator that stores the company graph with the company referral score for each of the plurality of nodes representing the plurality of companies.

6. The system of claim 5 further comprising a company connector operably coupled to the company graph constructor that identifies at least one relationship connection to a company of the plurality of companies for the at least one of the plurality of the communicants.

7. A computer system for job matching, comprising:
a processor;
a message processor operably coupled to the processor that retrieves and parses into a plurality of message elements a plurality of messages between the candidate and a plurality of communicants from at least one messaging system used by the candidate;
a referral network generator operably coupled to the message processor that receives the plurality of message elements of the plurality of messages between the candidate and the plurality of communicants and generates a reference graph with a reference strength score for each of the plurality of communicants indicating the strength of the relationship with the candidate;
a company graph constructor operably coupled to the referral network generator that constructs a company graph of a plurality of nodes representing a plurality of companies with which at least one of the plurality of nodes representing the plurality of the communicants has a relationship connection;
a company referral score generator operably coupled to the company graph constructor that generates a company referral score for each of the plurality of nodes representing the plurality of companies, the company referral score indicating a strength of a relationship between one of the plurality of communicants and the company with which the one of the plurality of the communicants has a relationship connection;
a job search engine operably coupled to the referral network generator that searches and retrieves a plurality of open jobs in the plurality of companies;
a job match engine operably coupled to the referral network generator that matches a profile of the candidate with the plurality of open jobs in the plurality of companies and generates a match score for each job match of an open job of the plurality of jobs, each match score weighted by the company referral score of the company of the plurality of companies that created the open job of the plurality of open jobs;
a referral ranking engine that ranks the plurality of open jobs by the match score for each job match of the profile of the candidate with the open job of the plurality of jobs, the match score weighted by the company referral score of the company of the plurality of companies creating the open job of the plurality of open jobs; and
a server storage operably coupled to the referral ranking engine that stores a short list of the plurality of open jobs ranked by the match score for each job match of the profile of the candidate with the open job of the plurality of jobs.

8. The system of claim 7 further comprising a personal recruiter application operably coupled to the job matching engine that serves the short list of the plurality of open jobs ranked by the match score for each job match of the profile of the candidate with the open job of the plurality of jobs for display on a computing device.

9. The system of claim 7 further comprising a job list generator operably coupled to the referral ranking engine that stores a list of references ordered by the reference strength score for each open job.

10. The system of claim 7 further comprising a company connector operably coupled to the company graph constructor that identifies the relationship connection to at least one company of the plurality of companies for each node of the plurality of nodes representing the plurality of the communicants in the referral graph.

11. A computer-implemented method performed by a processor for discovering a referral to a company for a candidate for employment, comprising:
receiving a plurality of messages between the candidate and a plurality of communicants from at least one messaging system used by the candidate;
generating a representation of a reference graph having a node representing the candidate and having a plurality of nodes representing the plurality of communicants, each of the plurality of nodes representing the plurality of communicants having a reference strength score indicating the strength of the relationship between the candidate and one of the plurality of communicants;
generating a representation of a company graph having a plurality of nodes representing a plurality of companies with which at least one of the plurality of nodes representing the plurality of the communicants has a relationship connection;
determining an eigenvalue for each of the plurality of nodes representing the plurality of companies;
determining a company referral score for each of the plurality of nodes representing the plurality of companies as at least one eigenvalue of a node of the plurality of nodes representing the plurality of companies, the company referral score indicating a strength of a relationship between one of the plurality of communicants and the company with which the one of the plurality of the communicants has a relationship connection; and
storing the company referral score for each of the plurality of companies.

12. The method of claim 11 further comprising storing a list of references ordered by the reference strength score for each of the plurality of companies.

13. A computer-implemented method performed by a processor for discovering a referral for a candidate for employment, comprising:
receiving a plurality of messages between the candidate and a plurality of communicants from at least one messaging system used by the candidate;
generating a representation of a reference graph having a node representing the candidate and having a plurality of nodes representing the plurality of communicants;
determining an eigenvalue for each of the plurality of nodes representing the plurality of communicants;
determining a value for the importance of each edge representing the plurality of messages between the candidate and the plurality of communicants, the value of the importance of each edge generated by determining a value for a communication balance between the nodes of each edge and a value for a communication importance between the nodes of each edge using the value of the communication balance;
determining a value for the importance of each of the plurality of messages between the candidate and the plurality of communicants, the value for the importance of each of the plurality of messages based upon an attribute whether a communicant of the plurality of communicants is directly addressed in a content of a message of the plurality of messages;
determining a reference strength score for each of the plurality of nodes representing the plurality of communicants as the product of a value for the importance of each of the plurality of nodes, a value for the importance of each edge, and a value for the importance of each of the plurality of messages between the candidate and the plurality of communicants, the reference strength score indicating the strength of the relationship between the candidate and one of the plurality of communicants; and
storing the reference strength score for each of the plurality of communicants.

14. The method of claim 13 further comprising sending to the online application a plurality of responses to a plurality of requests for information to generate a candidate profile.

15. The method of claim 13 further comprising sending a request to an online recruiting application to apply to at least one of the plurality of jobs matched using the job profile of the job for which the candidate was rejected.

16. A computer-implemented method performed by a processor for job matching, comprising:
receiving a plurality of messages between a candidate and a plurality of communicants from at least one messaging system used by the candidate;
generating a representation of a reference graph having a node representing the candidate and having a plurality of nodes representing the plurality of communicants, each of the plurality of nodes representing the plurality of communicants having a reference strength score indicating the strength of the relationship between the candidate and one of the plurality of communicants;
generating a representation of a company graph having a plurality of nodes representing a plurality of companies with which at least one of the plurality of the communicants has a relationship connection, each of the plurality of nodes representing the plurality of companies having a company referral score indicating the strength of the relationship connection between a company of the plurality of companies and the candidate;
retrieving a plurality of open jobs in the plurality of companies;
matching a profile of the candidate with the plurality of open jobs in the plurality of companies;
generating a match score for each job match of the matching the profile of the candidate with an open job of the plurality of jobs, the match score weighted by the company referral score of the company of the plurality of companies that created the open job of the plurality of open jobs;
ranking the plurality of open jobs by the match score for each job match of the profile of the candidate with the open job of the plurality of jobs, the match score weighted by the company referral score of the company of the plurality of companies creating the open job of the plurality of open jobs;
storing a short list of the plurality of open jobs ranked by the match score for each job match of the profile of the candidate with the open job of the plurality of jobs; and
serving the short list of the plurality of open jobs ranked by the match score for each job match of the profile of the candidate with the open job of the plurality of jobs for display on a computing device.

17. The method of claim 16 further comprising searching for at least one open job in each of the plurality of companies.

18. The method of claim 16 wherein storing the short list of the plurality of open jobs ranked by the match score for each job match of the profile of the candidate with the open job of the plurality of jobs further comprises storing a list of references ordered by the reference strength score for each open job.

19. The method of claim 16 wherein the serving the short list of the plurality of open jobs ranked by the match score for each job match of the profile of the candidate with the open job of the plurality of jobs for display on a computing device further comprises serving a list of references ordered by the reference strength score for each open job for display on the computing device.

20. A computer system for job matching, comprising:
means for receiving a plurality of messages between a candidate and a plurality of communicants from at least one messaging system used by the candidate;
means for generating a representation of a company graph having a plurality of nodes representing a plurality of companies with which at least one of the plurality of the communicants has a relationship connection, each of the plurality of nodes representing the plurality of companies having a company referral score;
means for matching a profile of the candidate with a plurality of open jobs in the plurality of companies;
means for generating a match score for each job match of the profile of the candidate with an open job of the plurality of jobs, the match score weighted by the company referral score of the company of the plurality of companies that created the open job; and
means for outputting a short list of the plurality of open jobs ranked by the match score for each job match of the profile of the candidate with the open job of the plurality of jobs.
